(19) United States
(12) Patent Application Publication
(10) Pub. No.: US 2008/0086954 A1
(43) Pub. Date: Apr. 17, 2008

(54) Minimizing The Stack Effect In Tall Buildings Having Vertical Shafts

(75) Inventors: Satish Narayanan, Ellington, CT (US); Timothy N. Sundel, West Hartford, CT (US); Brian E. Wake, South Glastonbury, CT (US); Lawrence E. Zeidner, Glastonbury, CT (US); Gregory M. Dobbs, South Glastonbury, CT (US); Pei-Yuan Peng, Manchester, CT (US)

Correspondence Address: CARLSON GASKEY & OLDS, 400 W MAPLE STE 350, BIRMINGHAM, MI, 48009, US

(73) Assignee: OTIS ELEVATOR COMPANY, FARMINGTON, CT (US)

(21) Appl. No.: 11/571,931

(22) PCT Filed: Oct. 26, 2004
(86) PCT No.: PCT/US04/35496

§ 371 Date: Jan. 11, 2007

Related U.S. Application Data
(60) Provisional application No. 60/593,026, filed on Jul. 30, 2004.

(51) Int. Cl. B66B 9/00; F24F 7/00

(52) U.S. Cl. 52/30; 454/254

(57) ABSTRACT

An elevator system (20) includes at least one vertical shaft (32) extending between at least two levels (24, 36) of a building (22). One of the levels (24) includes at least one passageway (28) between an interior of the building and the outside environment. At least one second shaft (40) extends between the other building level (36) and at least one other level within the building. The interior of the second shaft (40) is isolated from airflow on the building level (24) that includes the passageway (28) to the outside environment.

Disclosed examples include enclosures (52) for isolating the first shaft (32) from airflow on at least one of the levels to which the first shaft provides access.

### FIELD OF THE INVENTION

This invention generally relates to controlling airflows within a building to minimize the stack effect potentially associated with vertical shafts within the building.

### DESCRIPTION OF THE RELATED ART

There are a variety of situations where airflow management and air pressure management within a building are desirable and necessary. Various building configurations require controlling airflows between the building interior and exterior, for example, to prevent undesirably large airflows through passageways (e.g., doorways) that provide access to the building. In some circumstances, the differences in temperature between the inside and exterior of the building and the building configuration itself result in a pressure differential between the building interior and exterior that can result in undesirably large drafts or even gusts between the building interior and the outside. The problem can be exacerbated by the opening and closing of interior doors, the dynamic wind pressures on the building facade or both. Such drafts alter the heat load of the building undesirably and, for example, may interfere with comfortable occupant passage through a doorway or the operation of the doors themselves.

One example of undesirable airflow through a passageway between an interior and exterior space may occur in a high rise building that includes a tall shaft such as an elevator hoistway or a stairwell. Such shafts contribute to the so-called stack effect when there are differences between the indoor and outdoor temperatures. The stack effect can result in large drafts of air through passageways (i.e., doorways) that provide access to the building when such passageways are open. The difference in pressure between the building interior and the outside environment causes such stack effect driven airflows.

More specifically, colder air outside of a building during the heating season is heavier than the warm air inside the building. The outside pressure is higher than the inside pressure at lower levels of the building. Under many circumstances at upper levels in high rise buildings, the outside pressure is lower than the inside pressure. Accordingly, when there is an opening at the lower levels (such as at a doorway at a lobby level entry to a building) air tends to infiltrate into the building. The air tends to flow towards the top of the building. As airflow tends toward a path of lesser resistance, the outside air entering the building tends to rise through a vertical shaft such as an elevator hoistway or stairwell towards the top of the building.

A typical approach to address such a situation is to attempt to seal the building from the outside environment. Insulation and caulking around window frames and other penetrations such as vents and good construction techniques can minimize parasitic paths due to infiltration and exfiltration. The current state of the art for sealing direct passageways between the building interior and exterior is typically accomplished using a vestibule with revolving doors or a double set of hinged doors. There are various shortcomings and drawbacks associated with these approaches. For example, revolving doors tend to limit the number of individuals that can pass through a doorway at any given time. To increase the potential traffic flow, larger revolving doors with larger motors have been introduced. This approach is not ideal because the larger equipment introduces additional cost and requires additional space and energy.

Another drawback associated with revolving doors is that individuals desiring to pass through an automatically moveable door tend to become anxious about timing their entry into the passageway based upon the motion of the door. In many situations, an individual is not allowed to move slowly or to stop once they enter the vicinity of the revolving door or they may be bumped by one of the rotating door panels.

There is a need for an improved arrangement that minimizes the occurrence of the stack effect to improve airflow management associated with the interior of a building. Additionally, it would be beneficial to be able to eliminate the requirement for revolving doors at building entrances. This invention addresses those needs while avoiding the shortcomings and drawbacks discussed above.

### SUMMARY OF THE INVENTION

As an example, consider an elevator system that includes a first hoistway that extends between a first building level, which includes a passage between an interior of a building and a space outside of the building, and a second building level. At least one second hoistway extends between the second building level and at least one other building level. The first hoistway is isolated from airflow in the second hoistway.

One example arrangement includes a plurality of the second hoistways that provide passenger service to a variety of levels within the building. The first hoistway provides passenger service from an entrance level to the level where passengers can access the other hoistways. Of course, elevator cars carry passengers throughout the hoistways.

An exemplary disclosed assembly for isolating the vertical shaft in a building includes an enclosure for surrounding an opening to the shaft and isolating the opening from a space on an opposite side of the enclosure. A plurality of doors are associated with the enclosure. At least a first one of the doors allows passage between the enclosure and the opening. At least a second one of the doors is spaced from the first door and allows passage between the enclosure and the space. A controller allows one of the doors to open only when at least one other of the doors is closed. Accordingly, the assembly isolates the interior of the vertical shaft from the space on the opposite side of the enclosure.

A disclosed method of controlling airflow in a building includes providing a first shaft that extends between a first building level and a second building level. The first building level includes a passage between an interior of the building and a space outside of the building. Isolating the interior of the first shaft at least from airflow on the first building level and providing at least one second shaft that extends between the second building level and at least one other building level effectively isolates the second shaft from airflow on the first building level.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates a building including an example elevator system design.

FIG. 2 schematically illustrates an example enclosure associated with an opening into a hoistway.

FIG. 3 schematically illustrates an alternative embodiment of an enclosure.

### DETAILED DESCRIPTION

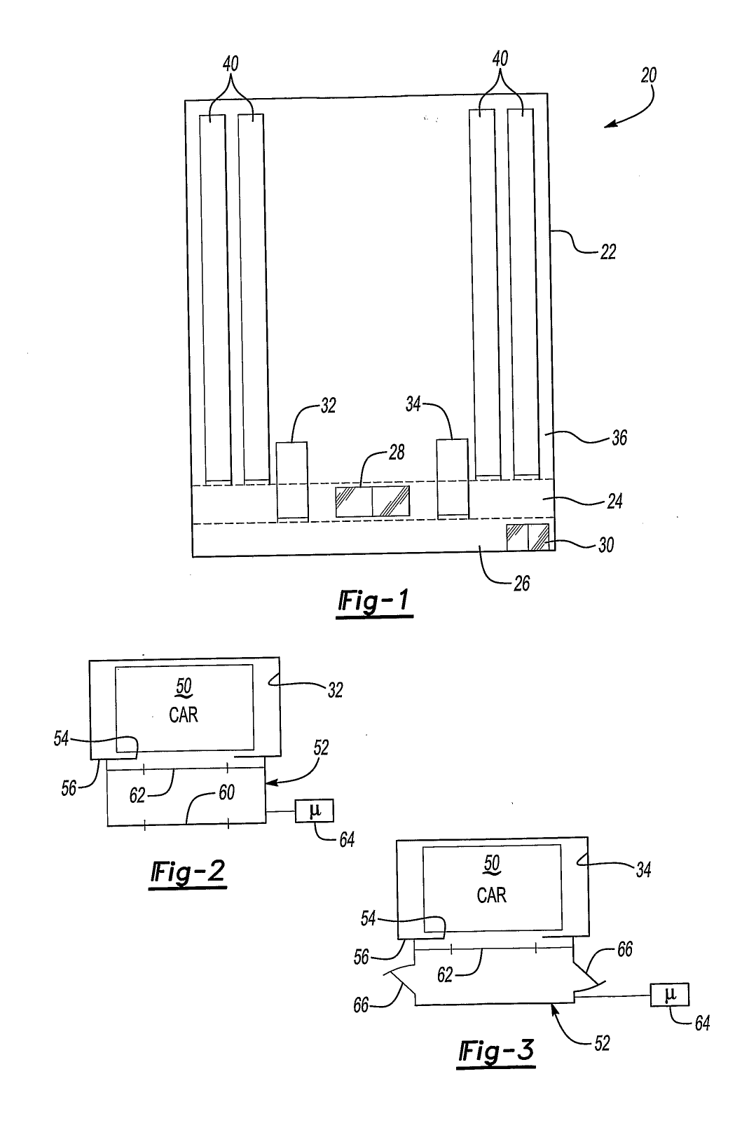

FIG. 1 schematically shows an elevator system 20 within a building 22. In this example, the building 22 is a high-rise building that has a first, lobby level 24 and a lower level 26 that include passageways (i.e., doorways) 28 and 30, respectively, that allow individuals to enter or exit the building 22. In one example, the passageways 28 and 30 provide openings for potential airflow communication between the interior spaces on the building levels 24 and 26 and the outside of the building.

A first vertical shaft 32, which is an elevator hoistway in one example, extends between the building level 24 and at least one second level 36 above the building level 24. Another vertical shaft 34 extends between the same building levels in this example. Vertical shafts 32 and 34 allow individuals entering the building 22 to access the building level 36 where they can then travel to higher levels within the building through one or more vertical shafts 40. In one example, a plurality of elevator hoistways are provided and each of the vertical shafts shown corresponds to a hoistway. In another example, at least one of the vertical shafts 40 comprises a stairwell.

Having separated vertical shafts 32 and 34 on the one hand and the vertical shafts 40 on the other hand allows for effectively isolating the building level 36 and those above it from the building levels 24 and 26, which include passageways to the outside of the building. By isolating the building level 36 and those above it, the vertical shafts 40 are isolated from airflow on the levels 24 and 26. Providing such isolation minimizes or eliminates the stack effect that otherwise may be associated with airflow through the passageways 28 and 30 into the building from the outside.

The vertical shafts 32 and 34 provide a vertical airlock that isolates the vertical shafts 40 from the airflow on the building levels 24 and 26, for example. In one example, each vertical shaft 32 and 34 is isolated from airflow on the building level 24. In another example, each shaft 32 and 34 is isolated from airflow on the building level 36. In still another example, the shafts 32 and 34 are isolated from airflow on both levels 24 and 36.

FIG. 2 schematically illustrates one example way of isolating a vertical shaft 32 from airflow on at least one of the levels 24 or 36. In the example of FIG. 2, the shaft 32 is an elevator hoistway that supports an elevator car 50 for movement in a conventional manner. An opening 54 to the interior of the hoistway 32 allows passenger access to the elevator car 50 in a known manner. An enclosure 52 is associated with the opening 54 to isolate the interior of the shaft 32 from the space on the opposite side of the enclosure 52 (i.e., the useable or occupied building space on a corresponding level). In this example, the enclosure 52 provides a generally sealed interface against a wall surface 56 near the opening 54 to the hoistway 32.

In the example of FIG. 2, the enclosure 52 includes a first door 60 that is spaced from a second door 62.

A controller 64 controls movement of the doors 60 and 62, which comprise sliding doors in this example. The controller 64 allows one of the doors 60 or 62 to open only when the other door 62 or 60 is closed. By keeping at least one of the doors 60 or 62 closed at all times, airflow from the space outside of the enclosure 52 is not permitted into the space within the shaft 32. Accordingly, the enclosure 52 provides isolation of the interior of the shaft 32 from airflow on the building level where the enclosure 52 is located. In one example, an enclosure 52 is provided on each building level to which the shaft 32 provides access. In the example of FIG. 1, an enclosure 52 may be provided at the level 24, the level 36 or both.

FIG. 3 schematically shows another example enclosure where the sliding door 60 is replaced with swinging doors 66. In this example, the controller 64 only allows one of the swinging doors or both to open when the sliding door 62 is closed. Similarly, the controller 64 only allows the sliding door 62 to open when both of the swinging doors 66 are closed.

By providing a vertical airlock to isolate upper building levels that are associated with vertically extending shafts such as elevator hoistways or stairwells from lower building levels that include passageways to an outside of the building, airflow management becomes possible without relying upon conventional techniques such as revolving doors for sealing the passageways between the building interior and the outside.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-14. (canceled)

15. An elevator system, comprising:
a first hoistway that extends between a first building level that includes a passage between an interior of a building and a space outside of the building and a second building level; and
at least one second hoistway that extends between the second building level and at least one other building level, the first hoistway being isolated from airflow in the second hoistway.

16. The elevator system of claim 15, including a plurality of the second hoistways.

17. The elevator system of claim 15, including an enclosure for controlling airflow between at least one of an opening between the first hoistway and the first building level or an opening between the first hoistway and the second building level.

18. The elevator system of claim 17, including the enclosure at each of the openings.

19. The elevator system of claim 17, including a plurality of enclosure doors spaced from each other and a controller that allows one of the doors to open only when at least one other of the doors is closed.

20. A method of controlling airflow in a building including:
providing a first shaft extending between a first building level and a second building level, the first building level including a passage between an interior of the building and a space outside of the building;
providing at least one second shaft extending between the second building level and at least one other building level; and
isolating an interior of the second shaft at least from airflow on the first building level.

21. The method of claim 20, including providing a plurality of the second shafts.

22. The method of claim 20, including isolating the interior of the first shaft from airflow on the second building level.

23. The method of claim 22, including isolating the interior of the first shaft from airflow on the first building level.

24. The method of claim 20, including providing an enclosure at an opening between the first shaft and the first building level that isolates the interior of the first shaft from airflow on the first level.

25. The method of claim 24, including providing an enclosure at an opening between the first shaft and the second building level that isolates the interior of the first shaft from airflow on the second level.

26. An assembly for isolating a vertical shaft in a building, comprising:
an enclosure for surrounding at least one opening of a vertical shaft that has a first opening at a first level in the building and a second opening at a second level in the building, the first level includes at least one passage between an interior of the building and a space outside of the building, the enclosure isolating the at least one opening from a space on a side of the enclosure opposite from the vertical shaft;
a plurality of doors associated with the enclosure, at least a first one of the doors allowing passage between the enclosure and the at least one opening and at least a second one of the doors spaced from the first one and allowing passage between the enclosure and the space; and
a controller that allows one of the doors to open only when at least one other of the doors is closed to thereby prevent airflow between the first and second levels through the vertical shaft.
